(19) United States
(12) Patent Application Publication
(10) Pub. No.: US 2005/0089306 A1
(43) Pub. Date: Apr. 28, 2005

(54) DVD video merging

(75) Inventors: Stuart A. Green, Sheffield (GB); Richard Allan Knight, Sheffield (GB)

Correspondence Address: WILMER CUTLER PICKERING HALE AND DORR LLP, 60 STATE STREET, BOSTON, MA, 02109, US

(73) Assignee: Zoo Digital Group Plc, Sheffield (GB)

(21) Appl. No.: 10/808,262

(22) Filed: Mar. 24, 2004

Related U.S. Application Data
(60) Provisional application No. 60/514,717, filed on Oct. 27, 2003.

(30) Foreign Application Priority Data
Oct. 27, 2003 (GB) GB 0324987.7
Nov. 5, 2003 (GB) GB 0325907.4

(51) Int. Cl. H04N 5/781

(52) U.S. Cl. 386/95; 386/125; 386/126

(57) ABSTRACT

Embodiments provide a method for merging first and second data associated with first and second DVD-Video zone directories respectively; the method comprising the steps of: identifying the registers used by at least one of the first and second data; allocating use of the registers to at least one of the first and second data according to said identifying; and creating data associated with video manager information (VMGI) of the DVD-video disc image data to accommodate at least one of the first and second DVD-Video zones.

### FIELD OF THE INVENTION

The present invention relates to a data processing system and method and more particularly, to a data processing system and method for merging digital content.

### BACKGROUND TO THE INVENTION

Current DVD-Video authoring tools use some form of user interface to define a project for producing a DVD-Video disc, that is, for producing the data structures and navigation information for such a DVD-Video disc. Ultimately such authoring tools eventually multiplex the video, audio and sub-picture parts, that is, the DVD assets, in accordance with the DVD-Video specification and format the result in files together with the associated navigation information to yield a DVD-Video disc image.

A significant limitation of prior art DVD authoring systems is that the authors must or usually use the same authoring tools for any given project. It will be appreciated that the situation is exacerbated if one contemplates creating a DVD or marshalling the assets to create a DVD-Video disc image using different authoring tools. Many authoring companies or facilities will use their preferred authoring tools. For example, a popular authoring tool is Scenarist available from Sonic Solutions. However, there are some aspects of the DVD specification such as, for example, seamless branching, that the Scenarist authoring tool does not support. Therefore, if an authoring company or facility is asked to undertake a project for which seamless branching is required, they will have to either decline that project or use a specialist tool with which they might be unfamiliar to author the DVD-Video disc image. It will be appreciated by those skilled in the art that using such an alternative authoring tool could be expensive, time consuming and inefficient as the company may only have one person, or a small number of people, who are familiar with the specialist authoring tool.

It is an object of embodiments of the present invention at least to mitigate some of the problems of the prior art.

### SUMMARY OF INVENTION

Accordingly, embodiments of the present invention provide a method for merging first and second DVD-Video zone directories (VIDEO_TS); the method comprising the steps of:

identifying the use of GPRM registers by at least one of the first and second DVD-Video zones;

allocating use of the GPRM registers to at least one of the first and second DVD-Video zones according to said identifying;

collating the first and second DVD-Video zones to create DVD-video disc image data; and

creating data associated with video manager information (VMGI) of the DVD-video disc image data to accommodate at least one of the first and second DVD-Video zones.

Advantageously, multiple authoring tools can be used to create or to author a single DVD-Video disc image or project.

A further advantage of embodiments of the present invention is that multiple authors can collaborate to work on the same project, either using separate copies of the same authoring tool, or using different authoring tools with the end products being merged using embodiments of the present invention.

### BRIEF DESCRIPTION OF THE DRAWINGS

Embodiments of the present invention will now be described, by way of example only, with reference to the accompanying drawings in which:

FIG. 1 shows schematically a file structure illustrating the format of the data units or assets forming a DVD-video disc image;

FIG. 2 illustrates schematically incorporation of video title sets into a DVD-Video disc image having a video manager and accompanying video title sets;

FIG. 3 depicts a flowchart for merging DVD-Video assets according to a first embodiment;

FIG. 4 illustrates an embodiment of the present invention for incorporating a video manager and associated video title sets into further video title sets; and

FIG. 5 shows a flowchart for merging DVD assets according to a second embodiment.

### DETAILED DESCRIPTION OF PREFERRED EMBODIMENTS

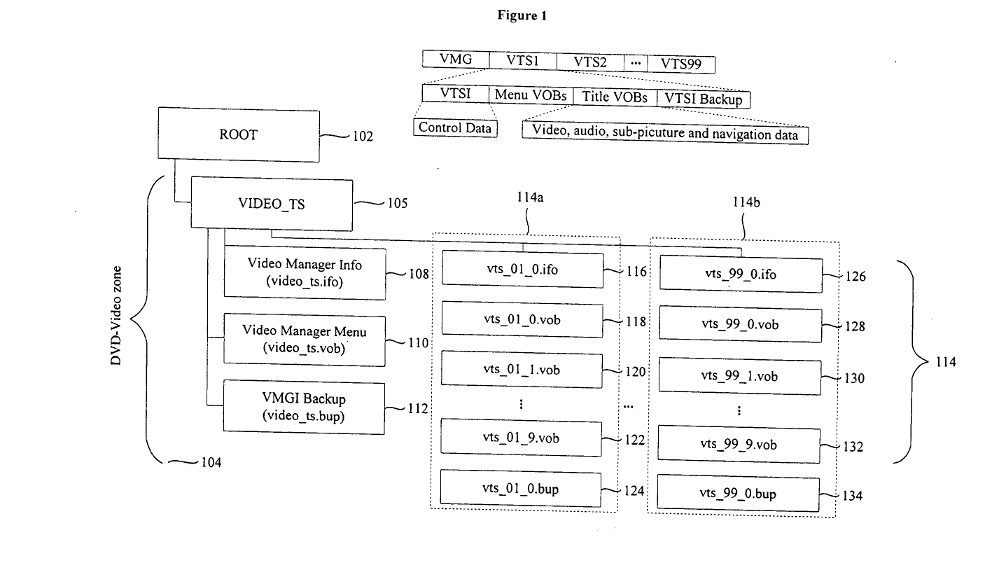

Referring to FIG. 1 there is shown schematically a file structure 100 or arrangement of a DVD-video file system. It can be appreciated that a root node 102 has a DVD-Video zone 104. The DVD-Video zone section 104 has a folder or directory named VIDEO_TS, 105, comprising information in the form of video manager information 108. The video manager information 108 comprises data representing or associated with a video manager (VMG) or from which such a VMG can be derived. The video manager information 108 has associated video manager menu information 110 that, typically, contains the initial menu presented to a user upon inserting a DVD into the associated player. Also illustrated is the conventional video manager information (VMGI) back-up 112. The DVD-Video zone 104 comprises data 114 representing video title sets (VTS1 to VTS99) that contain control data, menu data, title VOBs (Video Objects comprising MPEG encoded video data, audio data, sub-picture data and navigation information) and backup information. It can be appreciated that a number of video title sets VTS1 to VTS99 comprising such data are illustrated. The data 114 representing each video title set of such video title sets VTS1 to VTS99 are represented by data arranged in groups of files. It will be appreciated that two groups of data 114a and 114b, representing two video title sets VTS1 and VTS99, are illustrated.

The groups of data 114a and 114b representing the video title sets VTS1 to VTS99 comprise files 116 and 126 containing, or representing, video title set information (VTSI), containing control data, files 118 and 128 representing, or containing, video object sets for menu, if appropriate, of corresponding video title sets VTS1 to VTS99, files representing 120 to 122 and 130 to 132, or containing data for, a number of title video objects (Title VOBs), which contain the video, audio, sub-picture data and navigation data, and files 124 and 134 containing data representing video title set back-up information (VTSI Backup). The file system 100 illustrated in FIG. 1 is used by the presentation engine and the navigation manager to render video and audio in accordance with signals received from a remote control when playing a DVD.

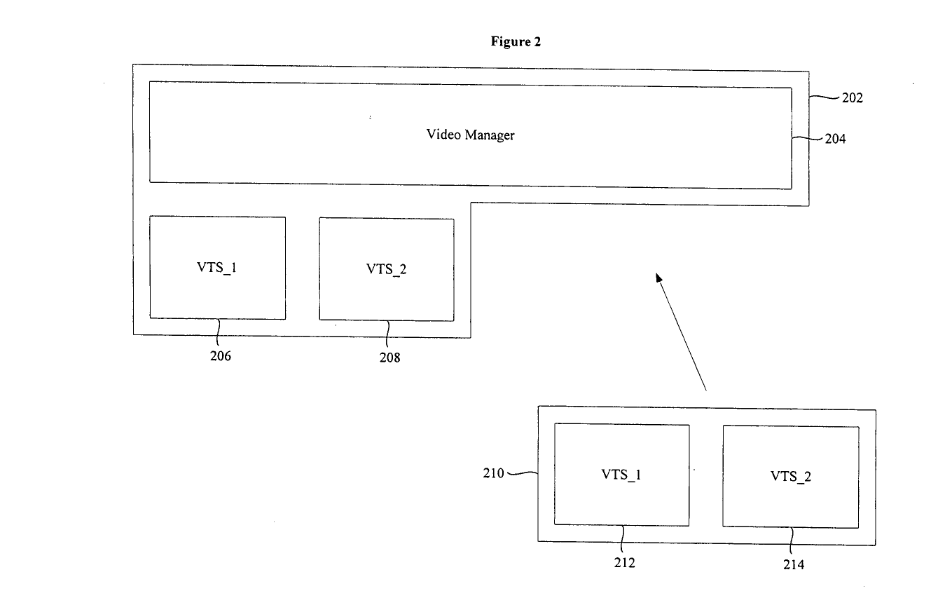

Referring to FIG. 2, there is shown schematically a process 200 for merging DVD-Video data according to a first embodiment. It can be appreciated that a first set of DVD-video data 202 comprises a video manager 204 and associated first and second video title sets 206 and 208. It will be appreciated that the first set 202 of DVD-Video data has been shown as comprising two VTSs. However, any other number, up to a maximum of 99 VTSs with current technology, could equally well be used by embodiments. In the example illustrated, it is desired to incorporate a second set 210 of video title sets, comprising, for illustrative purposes only, two video title sets 212 and 214 authored by a different authoring tool or a different author using the same authoring tool to the one used to produce a first set of DVD-video image data 202. It will be appreciated that any other number of VTSs could be merged into the first set 202 according to requirements, up to a maximum of 99 according to the limits of current technology.

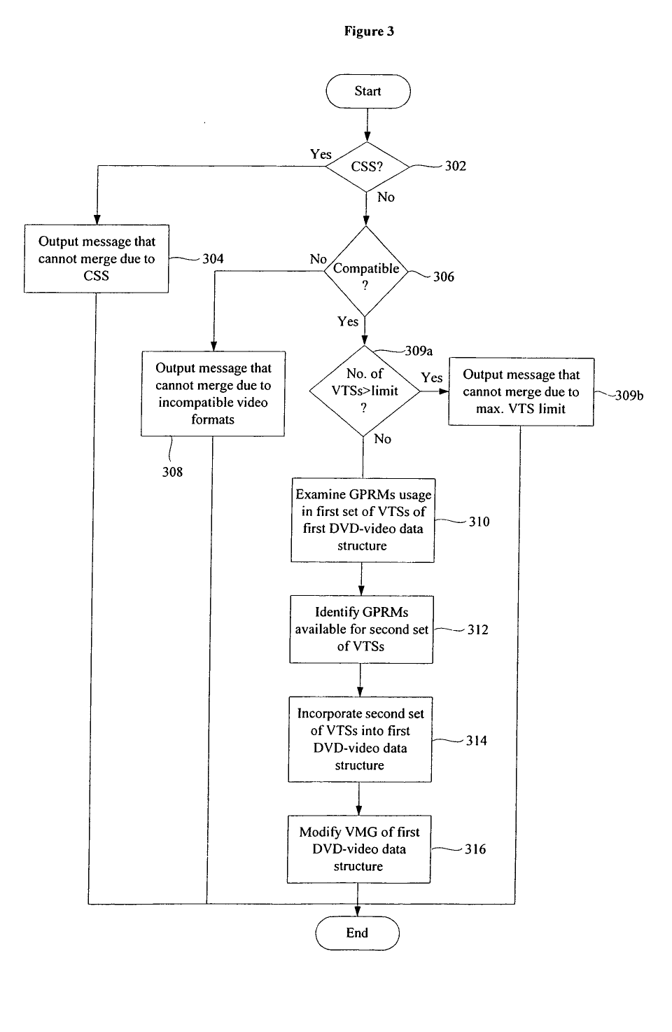

Referring to FIG. 3, there is shown a flowchart 300 for incorporating the second set 210 of video title sets 212 and 214 into the DVD-Video data 202 according to an embodiment. At step 302, a determination is made as to whether or not the second set 210 of DVD-Video data or the first set 202 of DVD-Video image data has been subjected to some form of content protection such as, for example, provided by a Content Scrambling System (CSS). If the determination at step 302 is that content protection (CSS) is effective, processing terminates with an optional message being output at step 304 indicating that the two sets of DVD-Video data 202 and 210 cannot be merged due to content protection being effective.

However, if the determination at step 302 is that content protection is not effective, or has not been applied to either of the DVD-Video data sets 202 and 210, a check is made at step 306 to determine if the video contained within the video title sets 206, 208, 212 and 214 is compatible, that is, a check is performed to ensure that they all conform to the one of the NTSC or PAL standards. If the determination at step 306 shows that the video contained within, or represented by, the video title sets 206, 208, 212 and 214 are incompatible, a message is output at step 308 to that effect and processing terminates.

However, if the video contained within, or represented by, the video title sets 206, 208, 212 and 214 are compatible, processing proceeds to step 309a, where it is determined if the total number of VTSs in the resulting merged DVD-video data would exceed a predetermined limit, which is 99 according to current technology, but could equally well be some other limit. If it is determined that the total number of VTSs would exceed the predetermined limit, a message to that effect is output at step 309b. If it is determined that the total number of VTSs would not exceed the predetermined limit, processing proceeds to step 310 where the use of the general parameters registers (GPRMs) of the first 206 and second 208 video title sets of the first set 202 DVD-Video data is determined.

At step 312, the GPRM registers not used by the first 206 and second 208 video title sets are deemed to be available for use by the first 212 and second 214 video title sets of the second set 210 of DVD-Video data.

The first 212 and second 214 video title sets of the second set 210 of DVD-Video image data are incorporated into or integrated into the first set 202 of DVD-Video image data at step 314. The video manager 204 is amended, at step 316, to include references to the newly incorporated first 212 and second 214 video title sets to allow those video title sets to be accessed in an appropriate manner from a menu, if provided, associated with the video manager 204. Steps 314 and 316 might be realised, for example, by copying files representing, or associated with, the first 212 and second 214 VTSs into an output area used by an authoring tool for authoring operations, and by adding to the VMG 204 of first set of DVD-Video data 202 (contained in VIDEO_TS.IFO and VIDEO_TS.BUP) attributes of, or associated with, the new VTSs 212 and 214.

It will be appreciated by those skilled in the art that step 314 comprises identifying the appropriate entry points and exit points for the first 212 and second 214 video title sets of the second set 210 of DVD-Video image data. Still further, the incorporation performed at step 314 comprises the step of modifying the exit points of the first 212 and second 214 video title sets of the second set 210 of DVD-video image data so that control is returned to the video manager 204 as appropriate.

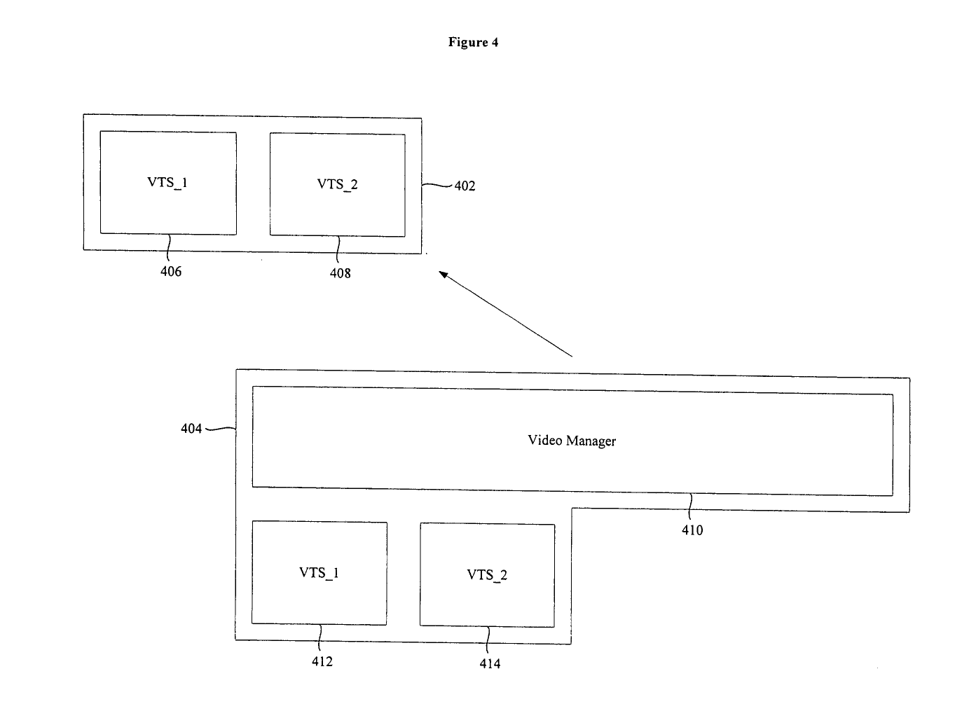

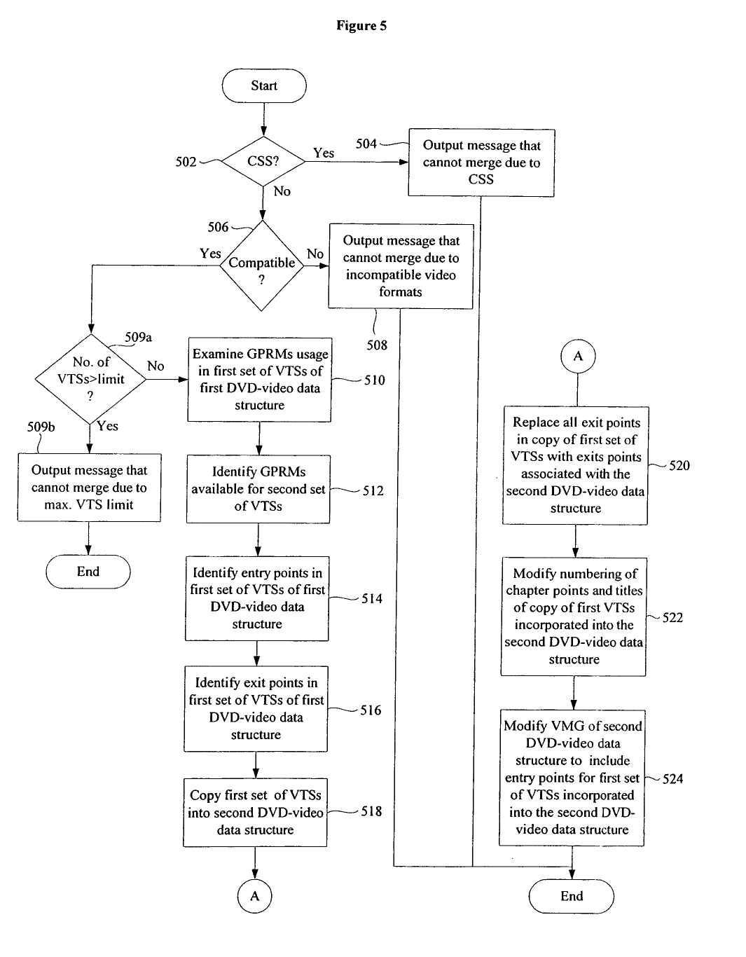

Referring to FIG. 4, there is shown schematically the construction 400 of DVD-Video data from a first set 402 of DVD-Video data produced using a respective authoring tool and a second set 404 of DVD-Video data produced using a different authoring tool or using a copy of the same authoring tool used by a different author. It can be appreciated that the first set 402 of DVD-Video data comprises first 406 and second 408 video title sets. Again, it will be appreciated that two VTSs have been shown for illustrative purposes only. Any number of VTSs could be processed in practice, subject to limits imposed by technical standards that might prevail from time to time. The second set 404 of DVD-Video data comprises a video manager 410 and respective first 412 and second 414 video title sets. Once again, two VTSs have been used for illustrative purposes only. In the embodiment shown, the second set 404 of DVD-Video data is incorporated into the first set 402 of DVD-video image data. In preferred embodiments, the incorporation is performed using the authoring tool used to produce the second set 404 of DVD-Video data. FIG. 5 shows a flowchart 500 for giving effect to the combination or incorporation illustrated by the embodiment shown in FIG. 4. A determination is made at step 502 as to whether or not content protection is effective in respect of either of the first set 402 or second set 404 of DVD-Video data. If it is determined that such content protection is effective, processing passes to step 504 where a message indicating that the DVD-Video data sets 402 and 404 cannot be merged or combined due to content protection being effective.

If the determination at step 502 is that content protection is not effective, processing proceeds to step 506 where it is determined whether or not the video represented by, or contained within, the video title sets 406, 408, 412 and 414 are compatible, that is, whether or not they are all NTSC or all PAL, for example. If the determination at step 506 is that the video represented by, or contained within, the video title sets 406 to 414 are incompatible, a message is output to that effect at step 508 together with an indication that the merging or combining process cannot be completed.

If the determination at step 506 is that the video standards are compatible, processing proceeds to step 509a, where it is determined if the total number of VTSs in the resulting merged DVD-video data would exceed a predetermined limit, which is 99 according to current technology, but could equally well be some other limit. If it is determined that the total number of VTSs would exceed the predetermined limit, a message to that effect is output at step 509b. If it is determined that the total number of VTSs would not exceed the predetermined limit, processing proceeds to step 510 where the use of the GPRM registers of the first set 402 of DVD-video data is determined. The registers not used by the first set 402 of DVD-Video data are identified at step 512 as being available for use by the second set 404 of DVD-Video data. The entry points in the first set 402 of DVD-Video data are determined, that is, the entry points for the first 406 and second 408 video title sets are determined at step 514. Furthermore, at step 516, the exit points for the first 406 and second 408 video title sets of the first set 402 of DVD-Video image are identified.

The first set 402 of DVD-Video data is copied into, or combined with, the second set 404 of DVD-Video data at step 518. All exit points in the VTSs of the first set 404 of DVD-Video data are replaced with navigation data that returns control to the video manager 410 of the second set 404 of DVD-Video data at step 520.

At step 522, the navigation data associated with the video manager 410 for accessing the first 406 and second 408 video title sets of the first set 402 of DVD-video image data are included in the video manager 410 or, more specifically, in the VMGI of the video manager 410 (contained in VIDEO_TS.IFO).

It will be appreciated by one skilled in the art that modifying the VMGI comprises establishing appropriate start sector addresses to allow a navigation manager to identify the start sector addresses or entry points for the newly added video title sequences. In practice such modifications entail doing a search-and-replace operation. The instructions that cause control to jump from one place to another are relative, if the jump is within the current VTS, and absolute if the jump is outside the current VTS. Thus, any jumps outside the current VTS must be reassigned to fit in with the new combined structure.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for merging first and second data associated with first and second DVD-Video zone directories respectively; the method comprising:
identifying the registers used by at least one of the first and second data;
allocating use of the registers to at least one of the first and second data according to said identifying; and
creating data associated with video manager information (VMGI) of the DVD-video disc image data to accommodate at least one of the first and second DVD-Video zones.

2. A method as claimed in claim 1 further comprising collating the first and second data to produce DVD-Video data.

3. A method as claimed in claim 1, in which at least one of the first and second data comprises at least one of a Group of Picture, a Video Object, a Video Object Set, a Video Object Unit, a Cell, Program, Part_of_Title, Program Chain, Title, Navigation Pack, Video Pack, Audio Pack or DVD-Video disc image data.

4. A method as claimed in claim 1 in which the step of creating comprises creating menu data of video manager menu data (video_ts.vob) to access at least one of the first and second data.

5. A method as claimed in claim 1, further comprising establishing a backup copy of the data associated with the video manager information.

6. A method as claimed in claim 5 in which establishing a backup copy of the data associated with the video manager information comprises creating VMGI backup information (video_ts.bup).

7. A method as claimed in claim 1 in which the first and second data were created using respective, different, authoring tools or by different authors using the same tool.

8. A method as claimed in claim 1, further comprising, prior to identifying, determining whether or not at least one of the first and second data has associated copy protection.

9. A method as claimed in claim 8 further comprising creating the first data using a respective authoring tool and performing the steps of determining by using that respective authoring tool.

10.

11. A method for merging first and second video data (VTS), the method comprising:
assessing potential use of a predeterminable resourceby at least one of the first and second video data;
allocating use of the predeterminable resource to at least one of the first and second video data according to the step of assessing;
collating the first and second video data to create DVD-Video data; and
creating data associated with video manager information (VMGI) of the DVD-Video data to accommodate at least one of the first and second video data.

12. A data processing method as claimed in claim 11, in which the predeterminable resource is at least one of GPRM registers, titles and part titles.

13. (canceled)

14. A data processing system comprising means to implement a method as claimed in claim 1.

15. (canceled)

16. A computer program comprising executable code to implement a method as claimed in claim 1.

17. A computer program product comprising storage storing a computer program as claimed in claim 16.
